(19) United States
(12) Patent Application Publication
(10) Pub. No.: US 2025/0245237 A1
(43) Pub. Date: Jul. 31, 2025

(54) SYSTEM AND METHOD FOR PROVIDING SEARCH SERVICE USING QUERY DATA

(71) Applicant: Kakao Corp., Jeju-si (KR)

(72) Inventors: Eun Ju OH, Seongnam-si (KR); Eun Jung LEE, Seongnam-si (KR); Soo Yeun JANG, Seongnam-si (KR); Su Min CHO, Seongnam-si (KR); Seung Hyung LEE, Seongnam-si (KR); Maria PARK, Seongnam-si (KR); Hye Jin KANG, Seongnam-si (KR)

(21) Appl. No.: 19/002,982

(22) Filed: Dec. 27, 2024

(30) Foreign Application Priority Data
Jan. 31, 2024 (KR) 10-2024-0015119

(51) Int. Cl. G06F 16/248; G06F 16/242

(52) U.S. Cl. CPC G06F 16/248; G06F 16/243

(57) ABSTRACT

Provided is a method for operating a server, the method comprising: acquiring query data through query-answer interaction with terminals; generating an answer to a user query input from a user terminal and providing the answer to the user terminal; and extracting a similar query to the user query from the query data in a response to a specified request, and providing a search result for the similar query to the user terminal.

### CROSS-REFERENCE TO RELATED APPLICATION

This application claims priority to and the benefit of Korean Patent Application No. 10-2024-0015119 filed in the Korean Intellectual Property Office on Jan. 31, 2024, the entire contents of which are incorporated herein by reference.

### BACKGROUND

### (a) Field

The present disclosure relates to a search service.

### (b) Description of the Related Art

Information search may require finding a specific target with relevant information, and a relationship may be required to be established, such as through conversational participation, before accessing the information. In addition, the information may be fragmented, making it challenging to comprehensively search for desired information using traditional search methods.

Recently, technologies enabling conversational interaction with large language models, such as generative pre-trained transformers (GPT), have been spotlighted. The GPT may serve as an effective information search tool as the GPT understands the user's context and intent through natural language processing, and provides the information by synthesizing and summarizing the same. A method is required to leverage this GPT capability in a search service.

### SUMMARY

The present disclosure attempts to provide a system and a method for providing a search service using query data.

The present disclosure also attempts to provide an interface screen for providing a search service.

According to some embodiments, provided is a method for operating a server, the method including: acquiring query data through query-answer interactions with terminals; generating an answer to a user query input from a user terminal and providing the answer to the user terminal; and providing a search result for a similar query to the user query to the user terminal, in a response to a specified request, the similar query to the user query being extracted from the query data.

The providing the search result to the user terminal may include: determining the similar query to the user query from the query data, based on at least one of query intent-based similarity, keyword similarity, keyword category similarity, or answer similarity; and providing the search result including an answer to each similar query to the user terminal.

The search result may further include information related to a questioner who entered the similar query, or response information to the similar query with corresponding answer.

The providing the answer to the user terminal may include generating the answer to the user query in a previous search context.

The method may further include: generating additional information related to the user query based on the query data; and providing the additional information displayed together with the answer to the user terminal.

The generating the additional information may include: extracting a main keyword included in the user query; and generating the additional information based on the number of queries regarding the main keyword in the query data.

According to some embodiments, provided is a method for operating a terminal, the method including: acquiring an answer to a user query from a server and displaying the user query and the answer; briefly displaying a search result for similar queries to the user query in response to a specified request; and displaying a specific similar query and entire answer to the specific similar query, in response to a request for a full view of the search result for the specific similar query.

The method may further include: transmitting, to the server, a new user query input while the specific similar query and the entire answer are displayed; and displaying an answer to the new user query that is received from the server, following the specific similar query and the entire answer.

The answer to the new user query may be generated from a search context that includes the specific similar query and the entire answer.

Thee search result may further include information related to a questioner who entered corresponding similar query, or response information to the corresponding similar query with corresponding answer.

The method may further include displaying additional information related to a main keyword of the user query near the user query or the answer.

According to some embodiments, provided is an application stored on a computer-readable storage medium and executed by a processor, the application including instructions for executing: acquiring an answer to a user query from a server and displaying the user query and the answer; briefly displaying a search result for similar queries to the user query in response to a specified request; and displaying a specific similar query and entire answer to the specific similar query, in response to a request for a full view of the search result for the specific similar query.

The application may include instructions for further executing: transmitting, to the server, a new user query input while the specific similar query and the entire answer are displayed; and displaying an answer to the new user query that is received from the server, following the specific similar query and the entire answer. The answer to the new user query is generated from a search context that includes the specific similar query and the entire answer.

The search result may further include information related to a questioner who entered corresponding similar query, or response information for the corresponding similar query with corresponding answer.

The application may include instructions for further executing displaying additional information related to a main keyword of the user query near the user query or the answer.

According to an embodiment, the search service may be provided using the accumulated query data through the query-answer interactions with the users.

According to an embodiment, the user may review the contents of other users' queries and their corresponding responses, thereby broadening the search scope and facilitating the achievement of the desired search goals through group search.

According to an embodiment, the user may conduct continuous searches while maintaining the context until reaching the desired information.

### BRIEF DESCRIPTION OF THE DRAWINGS

FIG. 1 is a schematic configuration diagram of a service system according to an embodiment.

FIGS. 2 and 3 are examples of an interface screen of a terminal for a query-answer interaction according to an embodiment.

FIGS. 4 and 5 are examples of an interface screen of a terminal according to an embodiment.

FIG. 6 is a flowchart of a method for providing a search service by a server according to an embodiment.

FIG. 7 is a flowchart of a method for providing a search service by a terminal according to an embodiment.

### DETAILED DESCRIPTION OF THE EMBODIMENTS

Hereinafter, embodiments of the present disclosure are described in detail with reference to the accompanying drawings so that those skilled in the art to which the present disclosure pertains may easily practice the present disclosure. However, the present disclosure may be implemented in various different forms and is not limited to the embodiments provided herein. In addition, in the drawings, portions unrelated to the description are omitted to clearly describe the present disclosure, and similar portions are denoted by similar reference numerals throughout the specification.

Throughout the specification, when any one part “includes” any one component, it may indicate the inclusion of other components rather than the exclusion of other components unless explicitly described to the contrary. In addition, a term “part”, “module”, or the like, described in the specification indicate a unit of processing at least one function or operation and may be implemented by hardware, software, or a combination of hardware and software.

A server may include one or more processors, a memory that loads a computer program executed by the processor, a storage device that stores the computer program and various data, and a communication interface. In addition, the server may further include various other components. The processor may be a device that controls an operation of the server, and may be any of a variety of processors that process instructions included in the computer program. For example, the processor may include at least one of a central processing unit (CPU), a micro processor unit (MPU), a micro controller unit (MCU), a graphics processing unit (GPU), or any other processor widely known in the art of the present disclosure. The memory may store the various data, instructions, and/or information. The memory may load the corresponding computer program from the storage device for the described instructions to operate the present disclosure to be processed by the processor. The memory may be, for example, a read only memory (ROM), a random access memory (RAM), or the like. The storage device may store the computer program and the various data non-temporarily. The storage device may include a non-volatile memory such as the read only memory (ROM), an erasable programmable ROM (EPROM), an electrically erasable programmable ROM (EEPROM), or a flash memory, a hard disk, a removable disk, or any form of computer-readable recording medium widely known in the art to which the present disclosure pertains. The communication interface may be a wired/wireless communication module that supports wired/wireless communication. The computer program may include instructions that are executed by the processor and may be stored in a non-transitory computer readable storage medium, the instructions causing the processor to perform operations in the present disclosure.

A terminal may include the computer program, which is software stored in the computer-readable storage medium, and hardware such as the processor, the memory, a display, or the communication module. The processor may collaborate with the hardware to execute the computer program. The display may display a user interface screen provided by the computer program and receive user input, for example, touch input. The communication module may communicate with the server through a communication network. The computer program may be software stored on the computer-readable storage medium, and include the instructions and data for executing the operation in the present disclosure. The computer program may include an application.

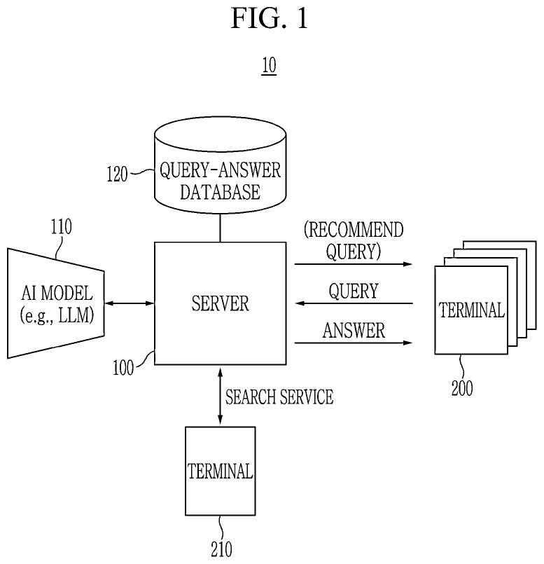

FIG. 1 is a schematic configuration diagram of a service system according to an embodiment.

Referring to FIG. 1, a service system 10 may include a server 100 and terminals 200 and 210 that install applications thereon and communicate with the server 100. The server 100 may be implemented to provide the terminals 200 and 210 with a specified service in conjunction with at least one artificial intelligence (AI) model 110. The various AI models 110 may be provided. For example, the AI model 110 may include a large language model (LLM) such as a generative pre-trained transformer (GPT), a generative-type AI model, or a conversation-type AI model. The AI model 110 may include a commercially available model and a model specialized for the present disclosure. The description assumes that the server 100 acquires query data through query-answer interactions with the plurality of terminals 200 and provides the terminal 210 with a search service using the query data. For convenience of description, the terminals are distinguished from each other, and the plurality of terminals 200 may also use the search service, and the terminal 210 may also send queries to the server 100 and receive answers. In addition, for convenience of description, it is assumed that a single application handles acquiring the query data and using the query data. However, a query data acquisition application and a search service application may be distinct from each other. The server 100 may provide various services, such as a chat service, the search service, and a combination of these services. For convenience of description, it is assumed that the server 100 provides the various services. However, the server 100 may not necessarily need to be a single server and may be implemented in various ways to provide the present disclosure.

The server 100 may provide the chat service for supporting message exchange in a chatroom. Here, the chat service is not limited to the chat service based on acquaintances (friends) but may include the chat service based on non-acquaintances or anonymity. It may encompass various forms and names of chat services that provide chat rooms. The chat service based on non-acquaintances or anonymity may include, for example, an open chat service provided by the KakaoTalk application.

The server 100 may provide the search service. The server 100 may search for information relevant to a query intent through search database exploration or in conjunction with the AI model 110, and generate the answer by synthesizing the searched information. The server 100 may classify the queries into a plurality of classes, such as precise search intent and generative search intent, using a query intent classification model and determine the query intent based on the probability of each class. Here, a method for analyzing the query intent may be implemented in various ways.

The server 100 may analyze the query intent regardless of a query format (e.g., keyword query or sentence query) and generate an answer in a form suitable for the identified query intent. If the server 100 analyzes the query intent as the precise search intent, the server 100 may search a search database for information corresponding to a precise answer and generate the answer using the retrieved information. The search database may include various types of collections (e.g., people collection and movie collection). If the query intent may not be the precise search intent, this query intent may be classified as the generative search intent. Generative search refers to the process of generating the answer in a new form by summarizing integrated information. Integrated information may be acquired through the large language model such as the GPT, and various accessible sources, including social media platforms (e.g., news and blogs), and document databases. The server 100 may generate the answer by combining precise search and the generative search in a complementary manner. That is, the server 100 may ensures that the answer obtained by the precise search and the generative search do not overlap. For example, the server 100 may distinguish between sources explored for the precise search and the generative search. If the query matches a people dictionary in the search database, the precise search may focus on the people collection, while the generative search may gather articles related to the queried person from news sources. If the query matches a place dictionary in the search database, the precise search may be performed on a place collection, and the generative search may be performed to search for information (e.g., reviews or ratings) related to the queried place from social media sources.

There are no restrictions on the query format, and a query that is ambiguous, requires value determination, or involves emotional exchange may be entered. Since providing a precise answer to such a query may not be feasible the server 100 may generate the answer by summarizing integrated information obtained through the AI model 110, which is trained using various data. The server 100 may additionally provide a user with related content (e.g., videos, music, reference documents, or websites) that is accessible to the user together with the answer. In this way, the server 100 may provide a search result optimized for the query intent.

A method for generating an answer to a query by the server 100 may be implemented in various ways. For example, the server 100 may segment the received query into semantic units, combine words corresponding to these semantics, query the search database (e.g., collections), and determine a reliable answer as the result of the precise search. For example, if the query is “Is GOTG3 fun?”, the server 100 may extract “GOTG3” and “fun” from the query, replace “GOTC3” with “Guardians of the Galaxy 3” or similar terms, expand “fun” with words such as “reaction”, “review”, “analysis”. The server 100 then query the search database (e.g., collections) using a combination of the replaced and expanded terms. Among these combinations, if an answer to “GOTG3 reaction” is deemed accurate, the server 100 may determine this answer to the query “Is GOTG3 fun?”. Alternatively, the server 100 may input the query “Is GOTG3 fun?” into at least one AI model 110 and generate the answer based on the model's output.

A method for determining the exposure order of answers by the server 100 may be implemented in various ways. For example, if a query closely matches information stored in the search database (e.g., the people collection), the query intent is more likely to correspond to the precise search intent. In such cases, the answer acquired through the precise search may be prioritized and exposed first. Conversely, if fewer answers are acquired from the search database for the query, it is more likely that the query intent corresponds to the generative search intent. In such cases, the answer generated through the generative search may be prioritized and exposed first, followed by the precise search or related content. Alternatively, the server 100 may determine the exposure order of the answers to be provided later based on responses information for similar queries and the answers. For example, the server 100 may provide various types of answers (e.g., precise answer and generative answer) to the users who entered queries similar to “Is GOTG3 fun?”, accumulate responses information (e.g., clicks), and prioritize displaying the answer type that receives a high response rate.

The server 100 may provide a query-related advertisement by incorporating it into the answer. The query-related advertisement may be provided in various forms. For example, an answer to the query “When is the cheapest time to fly from Gimpo to Jeju?” may include an advertisement for a flight ticket sales website together with the generative answer. An answer to the query “Recommend a nutritional supplement for women in their 20s” may include an advertisement for a nutritional supplement product together with the generative answer.

The server 100 may provide a recommended query within the answer. If the recommend query included in the answer is selected, the server 100 may provide an answer to the selected query.

The server 100 may recognize the search context for previous queries and answers, and generate an answer to the current query through continuous exploration that maintains the context. The server 100 may recognize the conversation context in the chatroom and generate an answer to a query accordingly. If the server 100 explores the answer to the current query, the server 100 may acquire a context-aware answer by connecting the previous query and answer, or at least a portion of conversation content, to the current query and inputting this information into the AI model 110. However, a method for acquiring the context-aware answer may be implemented in various ways.

The server 100 may recommend an input query to the user. For example, the server 100 may recommend a popular query determined based on query statistics from users to the terminal 200. An answer to a popular query may be either pre-stored or newly generated. The server 100 may recommend the newly trending query generated based on the latest news to the terminal 200. The server 100 may recommend a query related to an input text to the terminal 200. The server 100 may recommend a random query that may be randomly selected to the terminal 200. The server 100 may recommend a chatroom-specific query considering the conversation context in the chatroom, or a user-specific query considering the user information such as the user's interests. In this way, the server 100 may reduce the inconvenience of users inputting queries and support the user in using the search service conveniently and enjoyably.

The server 100 may generate the answer to the query through various types of interaction and store the same in a query-answer database 120. The query and the answer may be stored in connection with the previous queries and answers, and information on a session where the query and the answer are generated may be mapped. The query-answer database 120 may manage the queries separately, manage the answers separately, and manage the grouped queries or answers.

The server 100 may cluster related queries based on the query data stored in the query-answer database 120, and a method for clustering the queries may be implemented in various ways. For example, the server 100 may generate a query group by grouping the query data stored in the query-answer database 120 based on relevance such as a subject or a field. The server 100 may generate the query group by grouping the query data stored in the query-answer database 120 based on similarity. For the sentence-form query, sentences may often not be identical to each other even if the query intents are the similar to each other. Therefore, the server 100 may cluster the related queries for processing the query statistics, recommending the queries, generating the answer, or the like.

The server 100 may provide the answer generated for the user query, together with additional query-related information extracted based on the query data. The additional query-related information may guide the user to make timely and interesting search by using other users' queries.

The additional query-related information may be provided in various ways, and may include, for example, popularity information related to the user query and a related keyword. For example, popularity may be measured based on a main keyword included in the user query, and displayed as the number of queries regarding the main keyword during a certain period of time. For example, if the user query is “Tell me about Son Heung-min's recent condition”, the server 100 may extract a main keyword “Son Heung-min”, calculate the number of queries that include the main keyword “Son Heung-min” in the query data during the certain period of time, and provide additional query-related information that “128 people are asking about Son Heung-min”. The additional query-related information may be configured to be selectable, and may be configured to provide a specified interface (e.g., a query collection interface) when selected. For example, the server 100 may respond to a selection of the additional query-related information to thus provide the terminal with “Son Heung-min” related-queries similar to “Tell me about Son Heung-min's recent condition”, and corresponding answers.

The server 100 may provide the search result including queries similar to the user query. The server 100 may extract the queries similar to the user query using the AI model 110.

Similarity with the user query may be calculated based on query intent-based similarity, keyword similarity, keyword category similarity, answer similarity, or the like. For example, if the user query is “Tell me about Son Heung-min's recent condition”, queries such as “I'm curious about the video of Son Heung-min's 100th goal” or “How is Tottenham these days?” may be determined as similar queries having a similar query intent, and the similar queries may be extracted using the AI model 110.

The server 100 may extract keywords from the queries and calculate the similarity based on whether the keywords match with each other. Here, the server 100 may assign importance to the keyword in a sentence based on a keyword feature and calculate the similarity using the keyword importance as a weight.

The server 100 may extract keywords from the queries and calculate similarity based on whether keyword categories match with each other. For example, in the user query “Tell me about Son Heung-min's recent condition”, the main keyword “Son Heung-min the main” may belong to the category “sports/soccer players”. Using the category, the server 100 may determine, a similar query, such as “What is Lee Kang-in's recent condition?” which shares the same category, “sports/soccer players” of the main keyword.

The server 100 may extract the keywords from the answers to the queries, and calculate similarity based on whether the keywords in the answers match each other. For example, if the answer to the user query “Tell me about Son Heung-min's recent condition” is “Son Heung-min became the captain of Tottenham”, the server 100 may extract a keyword “Tottenham” from the answer, excluding the main keyword “Son Heung-min” from the query, and determine a similar query, such as “How is Tottenham these days?” where “Tottenham” serves as the main keyword.

The server 100 may implement various methods to expose the search result of the similar queries. For example, the server 100 may determine the exposure order of the query data based on the similarity to the user query, the response to queries/answers (e.g., number of likes, number of replies, or number of selections), a queried frequency, or the like.

The server 100 may recognize the search context for the previous queries and answers through a follow-up query function for the search result, and generate the answer to the current query.

The server 100 may generate a new answer with high user engagement by analyzing user responses to previous answers. For example, if the user frequently selected multimedia content such as videos and images in the answers, the server 100 may generate the answer that includes relevant videos or similar content.

The server 100 may generate the answer that does not overlap with the previous answer when receiving a query that matches a search result or a similar query. For example, the server 100 may generate the answer by referencing a different source, such as news articles, for the new answer, or may generate the answer in a different format than the previous answer.

The terminal 200 or 210 may execute the application and access the server 100 to use the chat service or the search service, implemented in the application. The terminal 200 or 210 may be any type of computing device capable of displaying an interface screen provided by the application and receiving user input. The description describes a mobile terminal as an example, and the terminal 200 or 210 is not limited thereto. The terminal 200 or 210 may include at least one processor for executing instructions included in the application, and the processor may execute the instructions to perform an operation described in the present disclosure. The application including the instructions may be stored on a computer-readable storage medium.

The terminal 200 may contribute to collection of the query data by the server 100 through the interaction with the server 100. The query data may be collected through various methods, and may be collected, for example, through the following search service in the chatroom.

The terminal 200 may provide various entry points in the chatroom to enter the search mode. For example, the chatroom may switch from chat mode to search mode, when a message input window in the chatroom is converted into a query input window through a specified user action in the chatroom (e.g., selecting a search button). The message input window may serve as a prompt input window for the user to input a query. Alternatively, through the selection of a message region displayed in chatroom, the search for a text or an image included in the message is requested. For example, a menu displayed if the user long-taps on the message region includes an option like “Ask a question”, and if the user selects the option “Ask a question”, a search request for the selected message is transmitted to the server 100.

The terminal 200 may receive the answer to the query from the server 100 and display the answer. The answer may be provided as the precise answer, the generative answer, or an answer including both the precise answer and the generative answer, based on the query intent analyzed by the server 100, and the type of answer and the order of the answers may be determined based on the query intent. The query and the answer may be displayed in various ways in connection with the chatroom.

The query data may be collected through various forms of query-answer interactions, including the search service in the chatroom.

The terminal 210 may enter the search service through the various entry points and display the search result including the answer to the query. The answer may be provided as the precise answer, the generative answer, or combination of both the precise answer and the generative answer, based on the query intent analyzed by the server 100, and the type of answer and the order of the answers may be determined based on the query intent. The answer may include the related content including the video or the like.

The terminal 210 may provide the generated answer to the user query, while also displaying the additional query-related information extracted based on the query data. The additional query-related information may include various additional information, and may include, for example, the popularity information related to the user query, such as “128 people are asking about Son Heung-min”, and the related keyword such as “Tottenham” or “Lee Kang-in”).

The additional query-related information may be implemented to be selectable. For example, in response to the selection of the additional query-related information, the terminal 210 may display the query, which is similar to the user query, and its answer. The terminal 210 may further display the similar query and its answer, together with information related to a questioner and/or response information to the query/the answer (e.g., number of likes, number of replies, or number of selections).

The terminal 210 may provide a search space configured to perform a follow-up query function. The terminal 210 may transmit, to the server 100, a query input into the query input window where the follow-up query function is implemented, and display the answer to the query in the search space. Here, the user may enter a follow-up query for the search result for the user's own query, or the search results for other users' queries.

In this way, the user may review the contents of other users' queries and their corresponding responses, thereby broadening the search scope, and facilitating the achievement of the desired search goals through group search. In addition, the user may conduct continuous searches while maintaining the context until reaching desired information.

The following description describes in detail the interface screen displayed on the terminal 200 or 210.

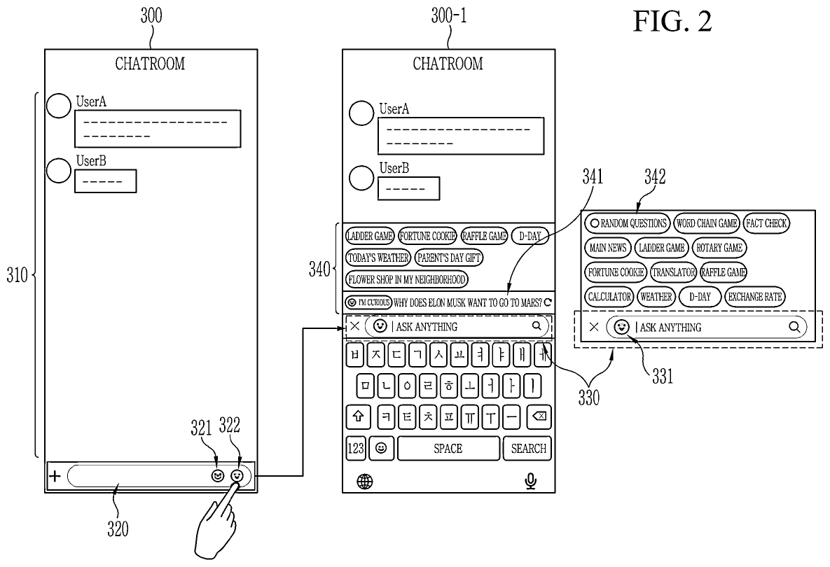

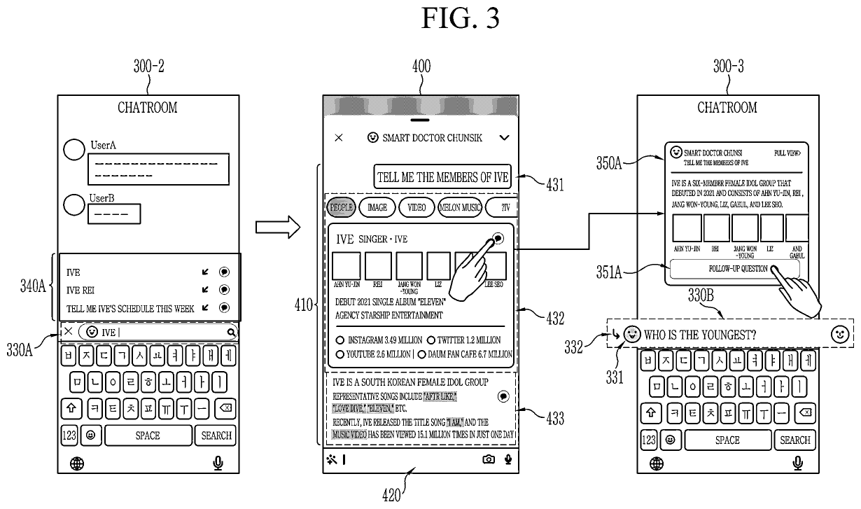

FIGS. 2 and 3 are examples of an interface screen of a terminal for a query-the answer interaction according to an embodiment.

Referring to FIG. 2, the query-answer interaction may be implemented in various services, and the search service in the chatroom is described as an example.

The terminal 200 may display a chatroom 300 provided by the application. The chatroom 300 may include a message display window 310 for displaying messages exchanged by participants, and a message input window 320 for receiving the user input such as text, photos, videos, or emoticon. If an emoticon button 321 is selected, an emoticon display window for showing the plurality of selectable emoticons may be displayed.

The chatroom 300 may provide the entry point that enables the switch from the chat mode to the search mode. For example, the chatroom 300 may display a search button 322 that enables entry into the search mode, and if the search button 322 is selected, the chatroom may transition to the search mode that enables the use of the search service in the present disclosure. For example, the search button 322 may be positioned near the message input window 320, and its position may be adjustable. Upon the selection of the search button 322, the message input window 320 may transform to a query input window 330, allowing users to enter queries.

In addition to the search button 322, the entry point that enables the entry into the search mode may be implemented in various ways. The chatroom may be switched to the search mode when a follow-up query for the search result shared in the chatroom is requested. In addition, selecting “Ask a question” from the menu that is displayed upon selecting the chatroom speech bubble (e.g., via a long-tap) may initiate a search for the text or the image included in the speech bubble.

A chatroom 300-1 switched to the search mode may display the query input window 330. The query input window 330 may be serve as the prompt input window. The query input window 330 may further include an indicator 331 showing that the chatroom is in the search mode, along with a text guide encouraging query input (e.g., “Ask me anything”). The terminal 200 may transmit the query input into the query input window 330 to the server 100 and receive the answer to the query.

The chatroom 300-1 switched to the search mode may display at least one recommended query in a specific region 340. The specific region 340 may be referred to as a suggestion region. For example, the specific region 340 may be disposed around the message input window, displayed on an upper layer of the message display window 310, or displayed on the same layer as the message display window 310 in a region that pushed the message display window 310 upward.

The recommended query may include, for example, the popular query, the newly trending query, the input text related query, or the random query. The recommended query may be provided in a keyword form or a sentence form. For example, a keyword (e.g., “today weather”, “Parents' Day gift”, or “flower shop in my neighborhood”) may be displayed in bubble format within a designated region 340, while a sentence-form query 341 may be displayed in a separate, distinct area. The popular query, the newly trending query, the chatroom-specific query based on the ongoing conversation context in the chatroom, the user-specific query tailored to the user information such as the user's preferences and interests may be recommended as the sentence-form query 341. If the recommended sentence-form query 341 or keyword (e.g., “today weather”) is selected, the selected query may be transmitted to the server 100. The recommended keyword or sentence-form query 341 may be updated manually or automatically. Additionally, a random question bubble 342 having a randomly implemented query function may be displayed in the specific region 340. If the random question bubble 342 is selected, the terminal 200 may receive a randomly selected query from the query list and its answer to the query.

Referring to FIG. 3, if the text is entered into a query input window 330A of a chatroom 300-2 that is switched to the search mode, the chatroom 300-2 may display at least one recommended query related to the input text in a designated region 340A. While the text is being entered, the recommended query may be dynamically updated to match the input text. The recommended query may be provided in the keyword form or the sentence form. For example, if the input text is “IVE”, Korean artist group, the recommended query may be “IVE”, “IVE REI”, “Tell me IVE's schedule this week”, or the like.

The terminal 200 may transmit the query input into the query input window 330A to the server 100 and display the received answer in a designated space, i.e., search room 400. The search room 400 in connection with the chatroom may be generated for each user who enters the query, and the search results with queries and answers for searches performed in the chatroom may be sequentially accumulated and displayed. The search room 400 may include a search display window 410 for displaying the queries and the answers and a query input window 420 for receiving the input query. If the query is entered into the query input window 420 in the search room 400, the query in a speech bubble form may be displayed in the search display window 410, and the answer received from the server 100 may be displayed. That is, the query displayed in the search room 400 may be a query input by the user in the search mode of the chatroom or a query input in the search room, and the queries and the answers may be accumulated and displayed in a form of the message. Therefore, when generating the answer to the input query, the server 100 may recognize the search context for existing queries and answers, and generate the answer to the current query through the continuous exploration that follows the context.

The search display window 410 may display the queries and their corresponding answers in the conversational format. For example, the search display window 410 may display a query “Tell me the members of IVE” 431 and its answers 432 and 433. Depending on the query intent analyzed by the server 100, the answer may be the precise answer, the generative answer, or a combination of both the precise answer and the generative answer. The type and the order of the answers may be determined based on the query intent. For example, for the query “Tell me the members of IVE” 431, the server 100 may determine that the precise search intent has a higher probability than the generative search intent through the query intent analysis, and may provide the terminal 200 with the search result including the answers generated based on the query intent. The search room 400 upon receiving the search result, may prioritize displaying the precise answer 432 derived from the people collection for “IVE”, and additionally display the generative answer 433, synthesized from the integrated information about “IVE”. The search result derived from the people collection may be provided in a card format, such as swiping through cards, though other presentation styles are also possible. The search result may be shared in the chatroom. For example, if the terminal 200

transmits a sharing request for the precise answer 432 to the server 100, a shared search result 350A may be displayed in a chatroom 300-3. The shared search result 350A may inform chatroom participants the query by further including the query “Tell me the members of IVE” together with the shared answer. In addition, the shared search result 350A may further include a button (e.g., “follow-up question” button) 351A to facilitate follow-up queries in the context of the shared query and answer.

If the user selects the follow-up question button 351A, the message input window in the chatroom 300-3 may switch to a query input window 330B, allowing the user to input a follow-up query, such as “Who is the youngest?”. Here, the query input window 330B may further display an indicator 332 showing that the follow-up query is made in the context of the previous search, along with an indicator 331 showing that the chatroom is in the search mode. The server 100 may generate an answer to the follow-up query “Who is the youngest?” in the context of the previous query “Tell me the members of IVE” and its corresponding answer, and provide the same to the terminal 200.

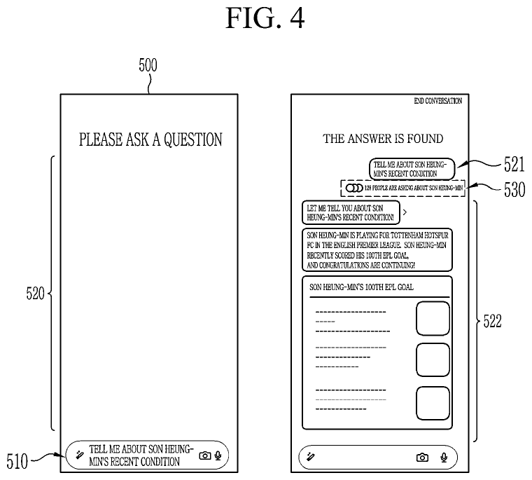

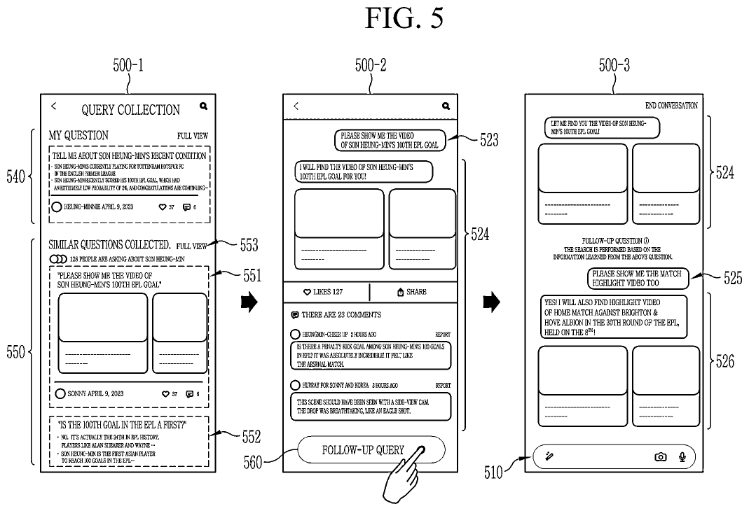

FIGS. 4 and 5 are examples of the interface screen of the terminal according to an embodiment.

Referring to FIG. 4, the terminal 210 may enter the search service through various entry points. The terminal 210 may provide a search space 500 for receiving the input query and displaying the search result including the answer to the query. The search space 500 may be configured in various ways, and may include, for example, a query input window 510 and a search display window 520 for displaying the search result including the query and the answer. The search display window 520 may accumulate and display the queries and the answers.

For example, if the query “Tell me about Son Heung-min's recent condition” is input into the query input window 510, the query 521 and the answer 522 received from the server 100 may be displayed in the search display window 520. The answer 522 may be provided as the precise answer, the generative answer, or combination of both the precise answer and the generative answer, based on the query intent analyzed by the server 100, and the type of answer and the order of the answers may be determined based on the query intent. The answer 522 may include the related content including the video or the like. If a new query is then input into the query input window 510, the answer generated by the server 100 in the context of the previous query 521 and the answer 522 may be displayed in the search display window 520.

Meanwhile, an initial query may not be necessarily input into the search space 500. For example, if the initial query “Tell me about Son Heung-min's recent condition” is input into the query input window displayed on any interface, the query may be shown the search space for providing the input query 521 and the answer 522.

The terminal 210 may provide the generated answer 522 to the query 521, while also displaying additional query-related information 530 generated based on the query data. The additional query-related information 530 may include various information, for example, the popularity information related to the query 521. The popularity may be measured based on the main keyword included in the query, and displayed as the number of queries regarding the main keyword during the certain period of time. For example, the additional query-related information 530 may be displayed as a text indicating the popularity of the main keyword included in the query, such as “128 people are asking about Son Heung-min”, and may be disposed near the query 521 or the answer 522. If the plurality of main keywords are included in the query, the text indicating the popularity of each main keyword may be displayed in a specified manner.

The additional query-related information 530 may be implemented to be selectable, and implemented to provide the specified interface (e.g., a query collection interface) when selected.

Referring to FIG. 5, the terminal 210 may display a query collection interface 500-1. For example, the query collection interface 500-1 may be displayed in response to a selection of the additional query-related information 530, or displayed through an entry point (e.g., via selection of a button or a swiping action).

The query collection interface 500-1 may include a region related to the user query (referred to as my question region) 540 and a region related to the similar query to the user query (referred to as similar question region) 550. The similar question region 550 may display search results 551, 552 that are related to the similar queries. The similar question region 550 may briefly display the search results of some of the similar queries. An interface providing a list of similar queries may be displayed when a full view button 553 on the query collection interface 500-1 is selected.

The query collection interface 500-1 may briefly display a pair of query and answer in a card format, along with information related to the questioner and/or response information to the query with the answer (e.g., number of likes or replies). For example, the search result 551 may provide the plurality of videos as a brief answer to the query, “Please show me the video of Son Heung-min's 100th EPL goal”, while also displaying a questioner's name (e.g., “Sonny”). If the questioner is selected, the information related to the questioner (e.g., public profile or history of queries) may be provided. The user may review the search results generated by others even if the user does not input the query directly.

If the user selects the search result 551 that is briefly displayed, an entire answer to the query, “Please show me the video of Son Heung-min's 100th EPL goal” may be displayed in a search space 550-2.

The search space 550-2 may display a query 523 and an answer 524 for the search result 551. The search space 550-2 may display a response to the answer 524. The search space 550-2 may provide a function to input the response (e.g., like or reply) to the answer 524.

The search space 550-2 may display a button (e.g., “follow-up query” button) 560 configured to perform the follow-up query function. In response to a selection of the button 560, a search space 550-3 may display the query input window 510, and if a query “Please show me the match highlight video, too” 525 is entered into the query input window 510, a query 525 and its answer 526 may be displayed. The server 100 may generate the answer 526 in a context of the previous search result 524.

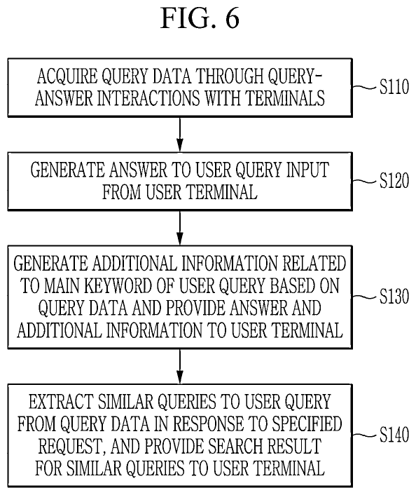

FIG. 6 is a flowchart of a method for providing a search service by a server according to an embodiment.

Referring to FIG. 6, the server 100 may acquire query data through the query-answer interactions with terminals (S110).

The server 100 may generate an answer to a user query input from a user terminal 210 (S120). The server 100 may generate the answer to the current query by considering the previous search context in a connected session. The server 100 may generate the answer to the query in conjunction with the AI model 110. The server 100 may search the search database for the information corresponding to the precise answer and generate the answer by using the retrieved information. The server 100 may generate the answer by summarizing integrated information acquired from various sources. The server 100 may generate the answer by using the different search methods (e.g., precise search and generative search) in the complementary manner. The server 100 may determine the exposure order of the answers acquired through the precise search and the generative search based on the query intent. The server 100 may generate the answer with the query-related advertisement.

The server 100 may generate additional information related to a main keyword of the user query based on the query data and provide the answer and the additional information to the user terminal 210 (S130). The additional information may be, for example, information indicating the popularity of the user query, and the popularity may be measured based on the number of queries are similar to the user query, with a higher number of similar queries indicating greater popularity. For example, the server 100 may extract the main keyword included in the user query, calculate the number of queries regarding the main keyword in the query data during the certain period of time, and generate the same as the additional query-related information.

The server 100 may extract the similar queries to the user query from the query data in a response to a specified request, and provide the search result for the similar queries to the user terminal 210 (S140). The server 100 may determine the query similar to the user query from the query data based on at least one of the query intent-based similarity, the keyword similarity, the keyword category similarity, or the answer similarity, and provide the search result including answers to the similar queries to the terminal 210. For example, the server 100 may determine the exposure order of the answers from the query data, based on the similarity with the user query, the response (e.g., number of likes, number of replies, or number of selections), the queried frequency, or the like. The search result for the similar query may be content displayed as the pair of query and answer in the card format, and may include information related to the questioner and/or the response information to the pair such as number of likes or replies.

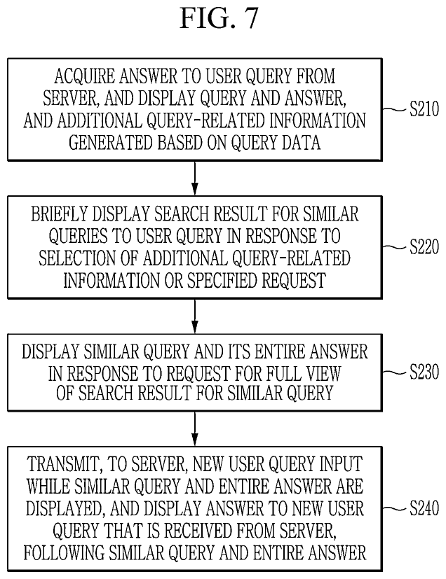

FIG. 7 is a flowchart of a method for providing a search service by a terminal according to an embodiment.

Referring to FIG. 7, the terminal 210 may acquire an answer to a user query from the server 100, and display the query and the answer, and the additional query-related information generated based on the query data (S210). The additional query-related information may be configured to be selectable, and configured to provide the specified interface (e.g., the query collection interface) when selected. The additional query-related information may be, for example, the information indicating the popularity of the user query, or the information on the main keyword in the user query (e.g., the number of queries related to the main keyword).

The terminal 210 may briefly display a search result for the similar queries to the user query in response to the selection of the additional query-related information or a specified request (S220). The search result for the similar query may be the content displayed as the pair of query and answer in the card format, and may include information related to a questioner and/or the response information (e.g., number of likes, number of replies, or number of selections). The terminal 210 may display the search result for the user query in my question region.

The terminal 210 may display the similar query and its entire answer in response to a request for a full view of the search result for the similar query (S230).

The terminal 210 may transmit, to the server, a new user query input while the similar query and the entire answer are displayed, and display an answer to the new user query that is received from the server, following the similar query and the entire answer (S240). The answer to the user query may be generated in the context of the previous search result displayed in the search space.

The flowcharts shown in FIGS. 6 and 7 are examples for describing the present disclosure, in which the order may be changed and the steps may be processed in parallel.

According to an embodiment, the search service may be provided using the accumulated query data through the query-answer interactions with the users.

According to an embodiment, the user may review the contents of other users' queries and their corresponding responses, thereby broadening the search scope and facilitating the achievement of the desired search goals through group search.

According to an embodiment, the user may conduct continuous searches while maintaining the context until reaching the desired information.

The embodiments of the present disclosure described above are not only implemented through the device and the method, and may also be implemented through a program that implements the function corresponding to the configuration in the embodiment of the present disclosure or a recording medium on which the program is recorded.

Although the embodiments of the present disclosure have been described in detail hereinabove, the scope of the present disclosure is not limited thereto. That is, various modifications and alterations made by those skilled in the art that use a basic concept of the present disclosure as defined in the following claims also fall within the scope of the present disclosure.

What is claimed is:

1. A method for operating a server, the method comprising:
acquiring query data through query-answer interactions with terminals;
generating an answer to a user query input from a user terminal and providing the answer to the user terminal; and
providing a search result for a similar query to the user query to the user terminal, in a response to a specified request, the similar query to the user query being extracted from the query data.

2. The method of claim 1, wherein the providing the search result to the user terminal comprises:
determining the similar query to the user query from the query data, based on at least one of query intent-based similarity, keyword similarity, keyword category similarity, or answer similarity; and
providing the search result including an answer to each similar query to the user terminal.

3. The method of claim 1, wherein the search result further includes information related to a questioner who entered the similar query, or response information to the similar query with corresponding answer.

4. The method of claim 1, wherein the providing the answer to the user terminal comprise
generating the answer to the user query in a previous search context.

5. The method of claim 1, further comprising:
generating additional information related to the user query based on the query data; and
providing the additional information displayed together with the answer to the user terminal.

6. The method of claim 5, wherein the generating the additional information comprises:
extracting a main keyword included in the user query; and
generating the additional information based on the number of queries regarding the main keyword in the query data.

7. A method for operating a terminal, the method comprising:
acquiring an answer to a user query from a server and displaying the user query and the answer;
briefly displaying a search result for similar queries to the user query in response to a specified request; and
displaying a specific similar query and entire answer to the specific similar query, in response to a request for a full view of the search result for the specific similar query.

8. The method of claim 7, further comprising:
transmitting, to the server, a new user query input while the specific similar query and the entire answer are displayed; and
displaying an answer to the new user query that is received from the server, following the specific similar query and the entire answer.

9. The method of claim 8, wherein the answer to the new user query is generated from a search context that includes the specific similar query and the entire answer.

10. The method of claim 7, wherein the search result further includes information related to a questioner who entered corresponding similar query, or response information to the corresponding similar query with corresponding answer.

11. The method of claim 7, further comprising displaying additional information related to a main keyword of the user query near the user query or the answer.

12. An application stored on a computer-readable storage medium and executed by a processor, the application comprising instructions for executing:
acquiring an answer to a user query from a server and displaying the user query and the answer;
briefly displaying a search result for similar queries to the user query in response to a specified request; and
displaying a specific similar query and entire answer to the specific similar query, in response to a request for a full view of the search result for the specific similar query.

13. The application of claim 12, comprising instructions for further executing:
transmitting, to the server, a new user query input while the specific similar query and the entire answer are displayed; and
displaying an answer to the new user query that is received from the server, following the specific similar query and the entire answer,
wherein the answer to the new user query is generated from a search context that includes the specific similar query and the entire answer.

14. The application of claim 12, wherein the search result further includes information related to a questioner who entered corresponding similar query, or response information for the corresponding similar query with corresponding answer.

15. The application of claim 12, comprising instructions for further executing:
displaying additional information related to a main keyword of the user query near the user query or the answer.
